SEQUENCE LISTING (2 sequences)

SEQ ID NO: 1 - DNA, 66 bp, Artificial Sequence
  Description of Artificial Sequence/note = Synthetic Construct
atggctaatgaccgagaatagggatccgaattcaatattggtacctacgggctttgcgctcgtatc

SEQ ID NO: 2 - DNA, 66 bp, Artificial Sequence
  Description of Artificial Sequence/note = Synthetic Construct
gatacgagcgcaaagcccgtaggtaccaatattgaattcggatccctattctcggtcattagccat

(19) United States
(12) Patent Application Publication
(10) Pub. No.: US 2009/0233801 A1
(43) Pub. Date: Sep. 17, 2009

(54) MICROSTRUCTURES AND USE THEREOF FOR THE DIRECTED EVOLUTION OF BIOMOLECULES

(76) Inventors: Markus Rarbach, Koln (DE); Ulrich Kettling, Koln (DE); Jens Stephan, Koln (DE); Andre Koltermann, Koln (DE)

Correspondence Address: Ballard Spahr Andrews & Ingersoll, LLP, SUITE 1000, 999 PEACHTREE STREET, ATLANTA, GA, 30309-3915, US

(21) Appl. No.: 12/435,916

(22) Filed: May 5, 2009

Related U.S. Application Data
(63) Continuation of application No. 10/478,809, filed on Apr. 22, 2004, now abandoned.

(30) Foreign Application Priority Data
May 31, 2001 (EP) 01113331.1

(51) Int. Cl. C40B 10/00; C40B 60/10

(52) U.S. Cl. 506/1; 506/38

(57) ABSTRACT

The invention relates to microstructures and the use thereof for the directed evolution of biomolecules.

The present invention relates to microstructures and the use thereof for the directed evolution of biomolecules.

### BACKGROUND OF THE INVENTION

In methods of directed molecular evolution, libraries containing a wide variety of variants of a biomolecule are used for the selection of variants which correspond to a predetermined goal of evolution. The cyclic repetition of variation, amplification and selection of variants generates optimized biomolecules.

Methods of directed molecular evolution are primarily based on the generation of a large number of DNA variants (genotype library). Starting from such a library of genotypes, the corresponding gene products are prepared, screened for their properties (phenotype) and accordingly selected. For examination, screening methods are found to be particularly advantageous due to their flexibility and general applicability as compared to other selection methods, for example, growth-coupled ones.

Screening methods are based on the spatial isolation of the genotype variants. This isolation of the genotypes ensures both the possibility to separately measure properties of the different phenotypes and the assignment of the genotype to the phenotype, which is indispensable for the selection and amplification of optimum genotypes. Since the number of variants to be examined can be very high, the segregation of the genotypes is usually effected in sample supports which include a large number of sample compartments in methods performed to date. For example, commercially available sample supports comprise 96, 384 or 1536 sample compartments. The number of sample compartments is chosen as high as possible in order to limit the number of sample supports required and the quantity of necessary assay reagents. A limiting factor in the development of sample supports having an even higher number of sample compartments is the handling of low quantities of liquids in such compartments. Viscosity and surface tension factors as well as the evaporation of fluid samples, which are of minor importance in larger volumes, put strong limits on this procedure.

It is the object of the invention to provide a screening method for directed molecular evolution which avoids the mentioned drawbacks of screening methods based on sample supports.

In principle, a method for achieving the same object has been known from WO 95/35492. The method described is suitable for separating by their properties sample components of a fluid mixture of samples conveyed in a capillary. A disadvantage of this method is the fact that a possibility for reducing the diffuse mass transport within the fluid stream is not provided. This drawback prevents the use of very small sample compartments because the diffusive loss of sample components prevents the practicability of the sought reactions in the sample compartment especially for small dimensions. Further, the technical realization of the method requires high demands on the mechanical positioning of the components. Such solutions are frequently found to be unstable and error-prone.

Further, from DE-A-19950385, an in-vivo screening method is known which enables the identification of per se unselectable activities in a target cell. The nucleic acid sequence to be examined is introduced in these target cells by transfection together with a reporter vector. The activity in the target cells or in their culture supernatant which results from the reporter is employed as a measure of the unselectable activity of the nucleic acid sequence examined and their identification. However, it is known that the use of methods for in-vivo expression is limited by some factors. Thus, intracellular nucleases or proteases can destroy the introduced genotype or the gene product. The gene products expressed can have a toxic or inhibiting effect on the host cells and thus adversely affect their effectiveness. In addition, the gene products can be expressed as an “inclusion body” in an insoluble form or biologically inactive form.

In contrast, the cell-free in-vitro expression is not bound to any cellular control mechanisms and enables a direct access to the expressed gene products without isolation operations. In addition, the preparation of artificial gene products is possible by incorporating modified non-proteinogenic amino acids.

The present invention describes a screening method in the microstructure according to the invention for the selective identification of genotypes based on cell-free in-vitro expression.

### SUMMARY OF THE INVENTION

It has been found that the screening of a set of samples and the selection or sorting of individual samples from this set can be effected in an in-vitro method in channel structures produced by microstructuring techniques. In these microstructures, the division into individual samples is effected by segregation using various fluid phases. Thus, the present invention relates to:

(1) a method for the cell-free (i.e., in-vitro) selection of genotype variants from genotype libraries in a microstructure, comprising the following sequence of reaction steps:
(a) combining a test fluid comprising a genotype library in an expressible form and expression aids suitable for cell-free expression with a separation fluid in the microstructure to form individual compartments of the test fluid;
(b) transporting the compartments through the microstructure, the expression of the genotype into the phenotype being effected in the compartments;
(c) detecting the phenotype in the compartments; and
(d) selecting the compartments in accordance with their phenotypes; and

(2) a microstructure for performing the method as defined above under (1), comprising:

a first supply channel for supplying a test fluid (102), especially a fluid containing a genotype, to a reaction channel;
a second supply channel for supplying at least one separation fluid (101) to the reaction channel;
a detection means (205) provided at the end of the reaction channel for detecting a reaction proceeded in the test fluid; and
a selection means for selecting the test fluid compartments (109).

### BRIEF DESCRIPTION OF THE FIGURES

Essential functions and properties of the method (1) according to the invention and the microstructure (2) according to the invention are further illustrated below with reference to the Figures. The Figures show schematic representations of various preferred embodiments of the microstructure according to the invention.

FIG. 1 schematically shows the general set-up of a microstructured channel structure.

FIG. 2 shows the functional set-up of a microstructured channel structure according to the invention with active building elements.

FIG. 3 schematically shows a microstructured channel structure with a combined assay fluid supply and detection area.

FIG. 4 schematically shows a microstructured channel structure whose reaction regions are equipped with individually controllable reaction channels.

FIG. 5 schematically shows a microstructure according to the invention employed for the selection of a sequence-specific endonuclease activity.

FIG. 6 shows a lateral view of the detailed set-up of the microstructure according to the invention as shown in FIG. 5, employed for the selection of sequence-specific endonuclease activity.

### DETAILED DESCRIPTION OF THE INVENTION AND THE FIGURES

The term “microstructure” within the meaning of the present invention designates three-dimensional objects having a channel structure. The dimensions of the channel structures are preferably within a range of from 0.1 μm to 100 μm width, more preferably between 1 and 10 μm. The aspect ratios are preferably within a range of from 0.1 to 10, more preferably around 1.

“Fluids” within the meaning of the present invention are liquids or gases. In detail, test fluids for producing the genotype compartments are aqueous solutions or suspensions of a complex composition which contain, in addition to DNA, all further essential components for the cell-free in-vitro expression of the genotype into the phenotype.

The “expression aids suitable for cell-free expression” within the meaning of the invention (also referred to as “essential components”) are derived from cellular transcription and/or translation systems and comprise components such as translation factors (initiation, elongation, termination factors), ribosomes (70S or 80S), tRNAs, aminoacyl-tRNA-synthases. Cell-free systems are cell extracts obtained by centrifugation and other purification techniques which have biological activity. Basically, cell lysates can be prepared from any cells. For cell-free in-vitro expression, various prokaryotic and eukaryotic cell lysates can be used. Preferably employed are extracts from E. coli cells (e.g., S30 extract), from reticulocytes (“rabbit reticulocytes”) and from wheat germs. The cell lysing is performed according to protocols known to the skilled person (in this connection, see, inter alia, Promega Corporation, Protocols and Application Guide, Third Edition, 1996, and references therein). It is also known to the skilled person that an efficient expression further requires additions of further components, such as nucleotides, amino acids, energy equivalents, energy-regenerating systems, cofactors such as Mg²⁺, buffer additions, optionally exogenous RNA polymerase, such as T7 RNA polymerase.

The genotype to be examined and expressed can be added in the form of different templates, such as circular or linear DNA or mRNA, respectively of cellular origin or in a synthetic form.

The starting templates and the expression system should be matched to one another. Thus, for example, coupled transcription/translation systems, such as S30 extract from E. coli, are preferably employed for the conversion of DNA.

For the preparation of DNA variants (genotype libraries), various methods can be employed.

Known in-vitro methods include “random nucleic acid mutagenesis” which is achieved, for example, by the use of polymerases having a high error rate (WO 92/18645), cassette mutagenesis (A. R. Oliphant et al., Gene 44, 177-183 (1986); M. S. Horwitz et al., Genome 31, 112-117 (1989)), error-prone. PCR (R. C. Cadwell and G. F. Joyce, PCR Methods Appl. 2, 28-33 (1992)), and “site saturation mutagenesis”. Further suitable is the use of “recombination chain reaction” (WO 01/34835), “DNA shuffling” (WO 95/22625), “staggered extension method” (WO 98/42728), or “random priming recombination” (WO 98/42728). Non-homologous recombination methods, such as “itchy”, may also be employed (M. Ostermeier et al., Nature Biotechnology 17, 1205-1209 (1999)).

To form the separation media compartments, water-immiscible fluids are employed. These are, in particular, hydrophobic inert organic-chemical substances which are present as a liquid phase at operation room temperature and operation pressure. Preferably employed are aliphatic or aromatic hydrocarbons, higher alkanols or alkanones, esters or ethers of higher hydrocarbons, halogenated hydrocarbons, mineral oils, silicone oils or mixtures of these substances.

In a preferred embodiment, an aqueous solution, suspension or emulsion containing the detecting reagents is employed as the assay fluid. Preferred detection reagents include substrates which undergo a measurable change from the interaction with the phenotype expressed from the genotype. Measurable changes include, inter alia, changes in the absorption spectrum, changes in the chromophorous, fluorophorous properties, changes in the measurable radioactivity.

Mixtures of substrates and reagents which result in a measurable final product stoichiometrically in a reaction cascade starting with the first substrate changed by the expressed phenotype may also be employed.

Preferably, substrates are employed which are coupled to defined functional and thus definedly detectable groups. Examples of such groups are fluorophorous markers, such as rhodamine green (Molecular Probes Inc., Oregon, USA) or Cy-5 (Amersham Biosciences Europe GmbH, Freiburg, Germany).

The substrates are always to be selected in accordance with the phenotype expressed and its activity spectrum. For example, for the selection of expressed protease variants, a peptide substrate coupled to a fluorophore can be employed.

The design of the assay fluid determines the selection parameters for a phenotype to be positively evaluated and thus also determines the selection of the correspondingly related genotypes.

In a preferred embodiment, the flow rate in the channels of the microstructures reaction substrate is between 10⁻⁷ ms⁻¹ and 10⁻² ms⁻¹, in a more preferred embodiment between 10⁻⁶ ms⁻¹ and 10⁻⁴ ms⁻¹.

Separation of the genotypes into individual compartments: In a preferred embodiment, each compartment contains one genotype. The segregation of the genotypes can be effected by a merely random distribution or else in a well-aimed manner by a direct detection by measuring technology and a corresponding isolation of the biomolecules bearing the genotype. The biomolecules bearing the genotype usually consist of double-stranded DNA, or in some cases of single-stranded DNA or RNA. In another embodiment, several genotypes are combined in one compartment to be able to examine a higher number of variants. Starting from the genotype, the corresponding phenotype is formed within the compartment. The segregation serves the two functions of separating the large number of phenotypes for measuring their properties and of coupling the genotype and phenotype, which enables the subsequent isolation of improved genotypes. The compartment volumes are generally within a range of between 0.01 and 10,000 fl, preferably within a range of between 0.1 and 1000 fl, more preferably between 1 and 100 fl.

Addition of assay reagents to the individual compartments: In the majority of applications, suitable reagents for the detection of the phenotype cannot be added when the genotype compartments are formed because, on the one hand, they may interfere with in-vitro methods for the expression of the phenotype, and on the other hand, an exact control in time of the course of the reaction is rendered more difficult by the early addition of the reagents.

Detection of the phenotype: The determination of the phenotypical properties of each genotype or each compartment is preferably effected by optical, more preferably fluorimetric methods. Suitable measuring methods for measuring in structural dimensions of down to a few 100 nm are described, for example, in DE 197 57 740.

Selection of genotypes: The selection of genotypes with a positively evaluated phenotype is primarily achieved by selecting the compartments corresponding to this positive phenotype. This differentiation into compartments containing positive or negative phenotypes is achieved by a spatial separation into corresponding selection reservoirs following detection.

The genotype is isolated from the individual selected compartments in the form of DNA or RNA and can be recycled into the process. This enables a new cycle of a goal-directed selection (using assay charges with a changed composition, for example).

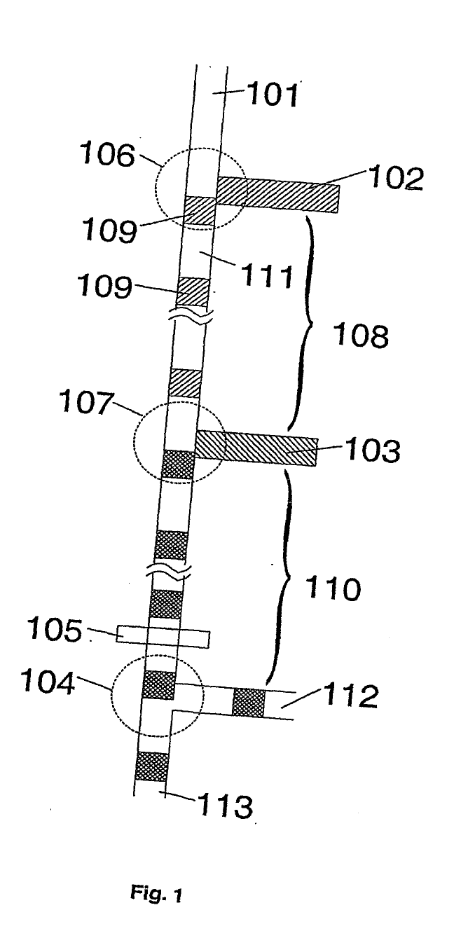

FIG. 1 schematically represents the set-up of a microstructured channel structure which combines these functions and thus enables the directed evolution of biomolecules.

The separation of the compartments for segregating the genotypes is effected by the intermittent addition of at least one test fluid (102) containing the genotypes and at least one separation fluid (101) in a compartmenting structure (106). The fluid (102) preferably contains all the substances necessary for the expression of the genotype, the composition of such fluids and methods for their preparation being known to the skilled person (Lesley, S. A., Methods Mol. Biol. 37, 265 (1995)). The separation fluid may be either an aqueous solution or a non-aqueous, preferably water-immiscible, liquid or a gas. For separating the genotype compartments (109), separation fluid compartments (111) structured in themselves which require the addition of several separation fluid components may also be used.

The temperatures of the two reaction areas I (108) and II (110) can be controlled by suitable thermal control elements. Both reaction areas (108 and 110) can be operated at the same or different temperatures, depending on the application.

The use of water-immiscible fluids or gases as the separation fluid (101) in combination with hydrodynamic flow in the microstructured reaction substrate is advantageous since a diffuse mass transport between genotype compartments (109) and between genotype compartments (109) and the separation fluid (101) can be minimized by this segregation of the genotype compartments. It is further advantageous that the axial dispersion is minimized by the use of water-immiscible fluids or gases as the separation fluid (101) in hydrodynamic flow. The expression of the genotype is effected in reaction area I (108). The reaction time can be freely chosen by the operator by selecting the length of the micro-structured reaction channel in the reaction area I and by selecting the fluid velocity in the reaction area I. The addition of reaction components for determining phenotypical properties of the biomolecules formed in the genotype compartment (109) in the reaction area (108) is effected in an area (107) of the microstructured substrate by combining an operator-chosen quantity of an assay fluid (103) with the genotype compartments (109). Preferably, the assay fluid (103) consists of a fluid which is miscible with or soluble in the genotype compartment (109). The conversion of the reaction components added with the assay fluid (103) by the biomolecules present in the genotype compartments (109) is effected in the reaction area II (110). The reaction time can be freely chosen by the operator by selecting the length of the microstructured reaction channel in the reaction area II and by selecting the fluid velocity in the reaction area II.

The measurement of the reaction products derived from the conversion of the components from assay fluid (103) and genotype compartment (109) is effected in a measuring area (105) of the reaction substrate. Preferably, spectroscopic measuring methods, most preferably methods of confocal fluorescence spectroscopy, are employed for measuring. Such methods are capable of determining the sample composition with high sensitivity in structural dimensions of a few 100 nm. The application of confocal detection methods for detecting minute amounts of substances is shown, for example, in DE4301005 and WO 95/35492.

Genotype compartments exhibiting positive measuring results in terms of the evolution goal must be separated from those exhibiting negative measuring results in order to separate advantageous variants of the library employed from disadvantageous ones. This separation is effected in a selection area (104) of the reaction substrate by a controlled direction of the genotype compartments into one of at least two selection channels 112 and 113.

All the mentioned process steps are advantageously combined and integrated in channel structures produced by microstructure technology. Such channel structures can be produced from different materials. These include metals (e.g., silicon), amorphous materials (e.g., glass), ceramic materials and polymeric materials (e.g., polyurethanes (PU), polydimethylsiloxanes (PDMS) and poly-methyl methacrylates (PMMA)). Preferably, the channel structures are prepared by deposition or ablation techniques in metallic, ceramic or amorphous materials. Advantages of these embodiments are the low tolerances of the structures which can be achieved, and a high functionality of the integrated building elements. In addition, soft lithographic methods and molding methods allow the preparation of microstructured reaction substrates from polymeric materials such as polyurethanes (PU) and polydimethylsiloxanes (PDMS). Since integrated functional elements are fixed with respect to each other within microstructured reaction substrates, essential advantages result here relating to the stability of the system as compared to other approaches.

Active building elements can be embodied as components of the microstructure in the form of shape memory elements, piezoelectric assembly or magnetostrictive elements. In a preferred embodiment, active building elements are embodied as shape memory elements. The integratable building elements include, for example, valves and pumps (T. Gerlach, M. Schuenemann and H. Wurmus, Journal of Micromechanics & Microengineering. 5(2): 199-201 (June 1995)).

In a preferred embodiment, active building elements are employed for segregation in a fluid flow and for the selection of selected compartments. In a particular embodiment, the active building elements are provided outside the microstructure, but directly connected therewith.

In another particularly preferred embodiment, the active building elements are within the microstructure, i.e., are components thereof.

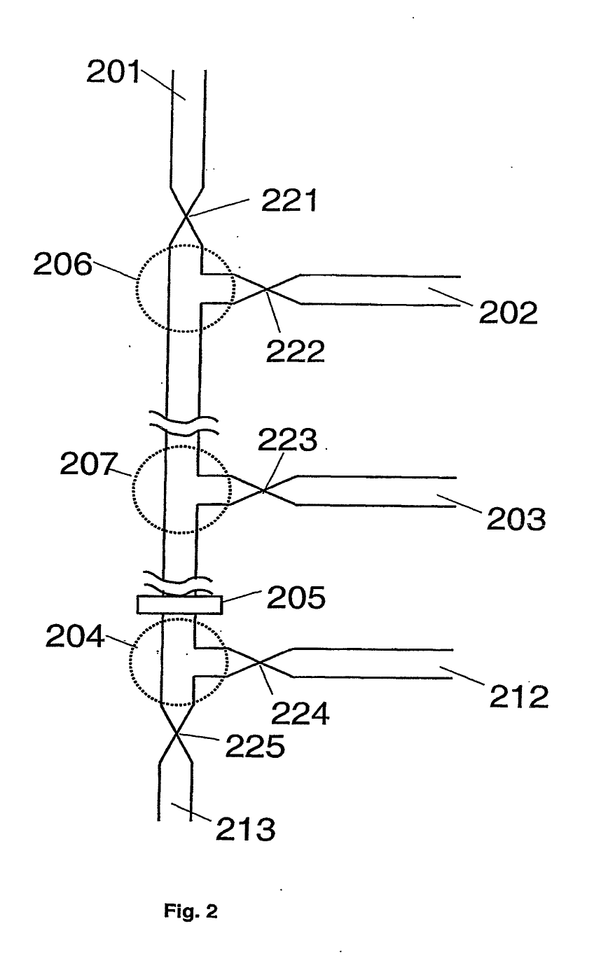

The functional set-up of a microstructured channel structure according to the invention with active building elements 221, 222, 223, 224 and 225 is represented in FIG. 2. The microstructured valve elements 221 and 222 which are connected with the first and second supply channels, respectively, serve to form the described compartmented fluid stream of fluid components 201 and 202 in the compartmenting element 206.

In a preferred embodiment, the valve elements are opened in a sequence and for a period of time predetermined by the operator and thus allow fluid elements of a defined volume to pass.

The valve element 223 (which may be designed like the valve elements 221 and 222) controls the addition of assay fluid 203 in the area 207. In a preferred embodiment, the controlling of the valve element is coordinated with the controlling of the valve elements 221 and 222 in such a way that assay reagents are added just when a genotype compartment is within the addition area 207. Especially when compressible fluids or microstructured reaction substrates of elastic materials are used, the coordination of valve elements 221, 222 and 223 may be insufficient to securely ensure the addition of the assay reagents to a genotype compartment in the addition area 207. In another preferred embodiment, the transport of a genotype compartment into the addition area 207 may then be determined by measuring technology, and the valve element 223 opened upon initiation by this measuring value. Optical measuring methods are preferably employed for detecting the genotype compartment in the addition area 207.

The valve elements 224 and 225 (FIG. 2) control the selection of the genotype compartments after the determination of their phenotypical properties in the detection area 205. For the selection of individual genotype compartments, the valve elements of said at least two selection channels 212 and 213 are opened alternatively (i.e., one at a time).

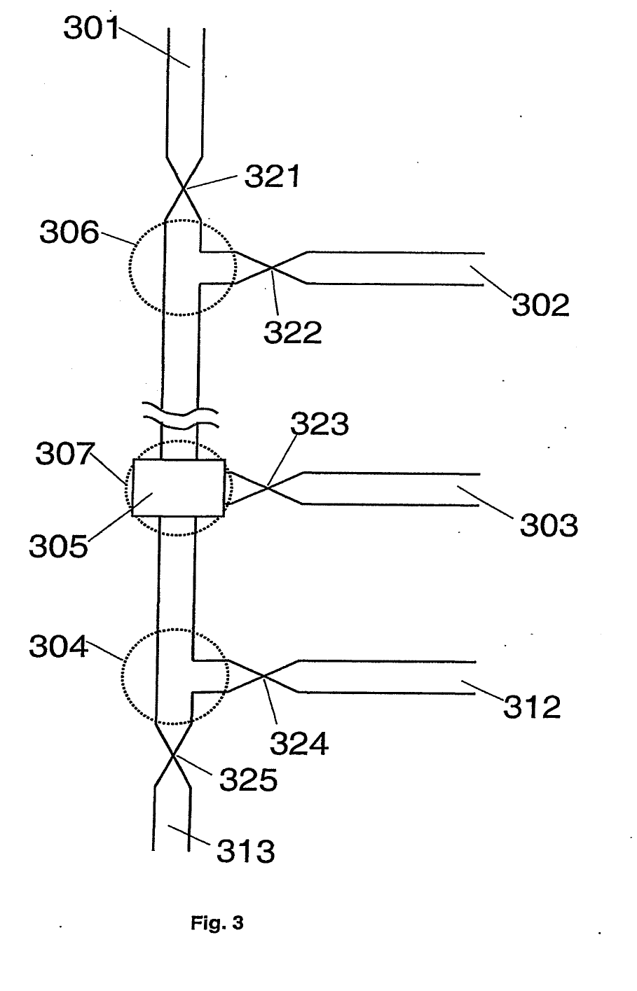

In another preferred embodiment as schematically represented in FIG. 3, phenotypical properties of the gene product formed can be determined in the direct environment of the assay fluid addition area (307). In this case, the micro-structured reaction substrate according to the invention is prepared in such a way that the assay fluid addition area (307) and detection area (305) coincide spatially, with omission of reaction area II (cf. FIG. 1, reaction area II (110)). An advantage of this embodiment is the fact that fast reactions between the gene product and assay reagents can thus be observed as measuring series resolved in time. Such time series measurements allow a better characterization of phenotypical properties of the gene product formed for fast reactions as compared to the determination of an individual measuring value after a predetermined reaction time determined by the selection of the length of reaction area II. The duration of the time series measurement can be extended, depending on the application, by interrupting the fluid stream in the microstructured reaction substrate by simultaneously closing the valve elements 321, 322 and 323.

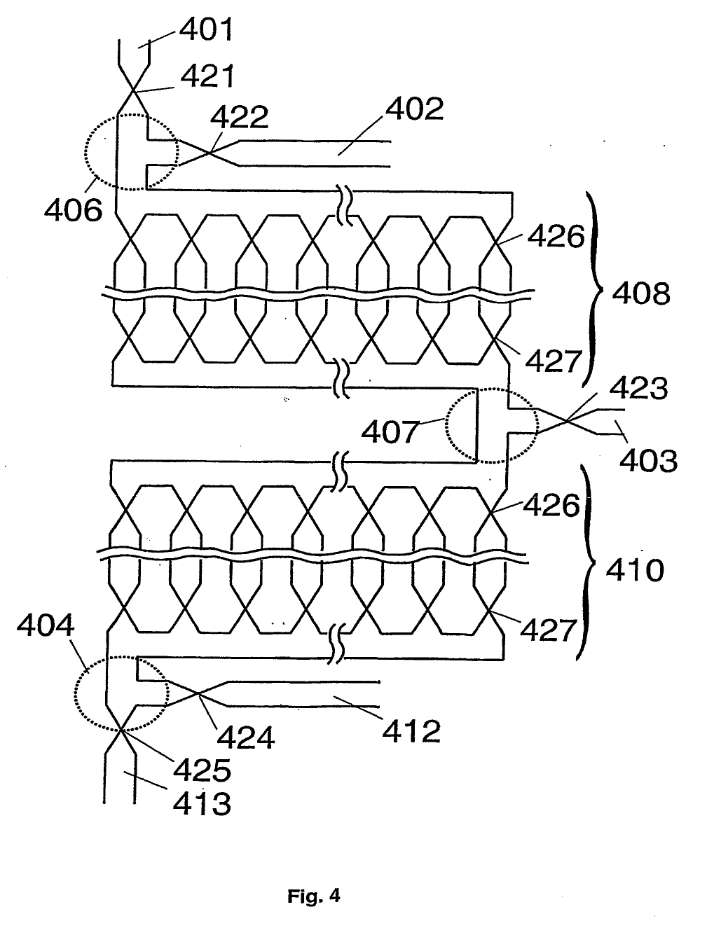

The dwelling time of sample compartments in the reaction areas 108 and 110 of the reaction substrate schematically represented in FIG. 1 is given by the length of the reaction area and the fluid velocity in this area. According to relations known to the skilled person, the pressure loss increases as the length of the channel structure increases in a hydrodynamic fluid transport. For very long reaction times and the thus necessary long reaction areas, the pressure required for hydrodynamic transport can be a technical prohibition of the construction of the micro-structured reaction substrate according to the invention. In this case, the embodiment outlined in FIG. 4 is an advantageous solution to the technical problem. The reaction areas 408 and 410 are embodied as separate reaction channels 427 which can be selected by opening individual valve elements 426. In the method according to the invention, individual channels are thus filled with the compartmented fluid stream after opening individual valves. Thus, the high number of designated reaction channels 426 can be filled. After a freely selectable reaction time has elapsed, the compartmented fluid present in the individual reaction channels can be displaced by another compartmented fluid or by a non-compartmented fluid and passed to the respectively next functional element (407) or (404).

According to the invention, the method is suitable for selecting biomolecules having particular phenotypical properties from a wide variety of variants. The variants can be prepared by in-vitro methods for the mutation of a DNA sequence of the starting phenotype. The method is particularly suitable for the selection of phenotypes having genotypes which are not cell-compatible. For example, a sequence-specific endonuclease activity is not cell-compatible if the cell lacks the methylase activity with the corresponding sequence specificity, since endogenous DNA is damaged by the catalytic activity of the expressed protein. Such a non-cell-compatible phenotype can be further found, for example, if the catalytic activity of an expressed protein has toxic effects on the cellular metabolism or other growth-inhibiting properties.

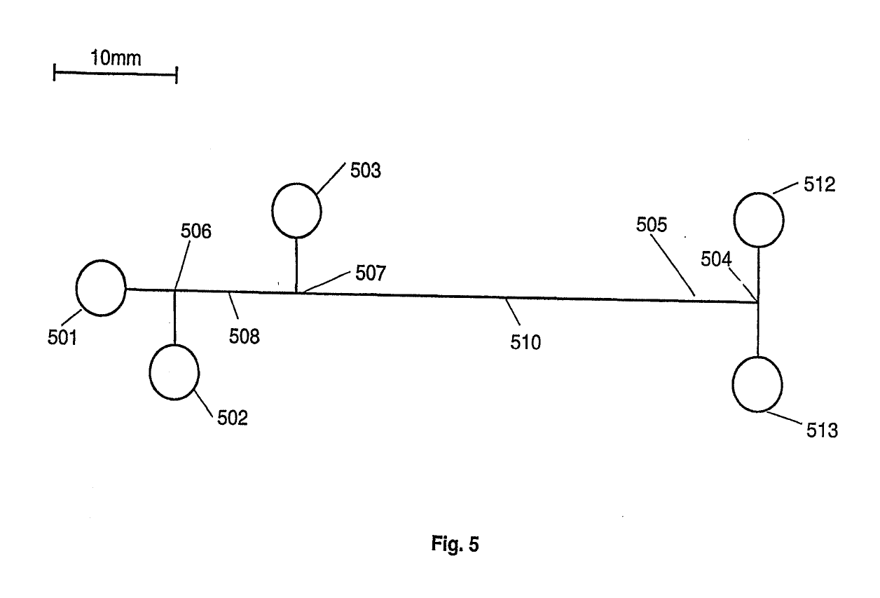

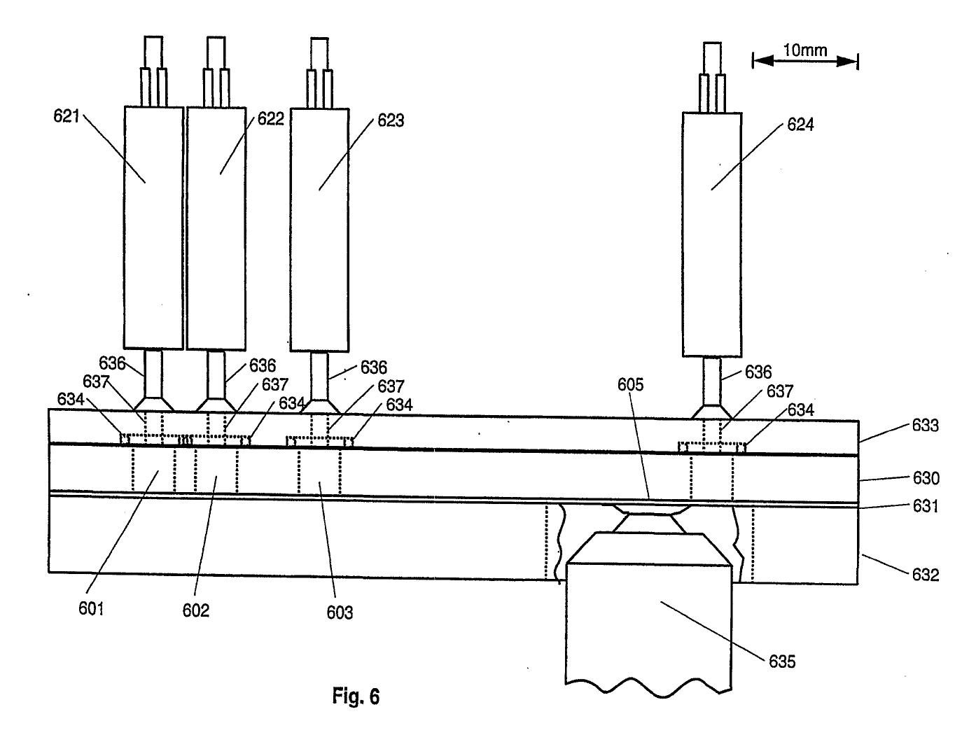

As described in the following Example, for the selection of a sequence-specific endonuclease activity, a microstructure design according to FIGS. 5 and 6 can be employed. FIG. 5 shows a microstructure which consists of the reagent supplies 501 (separation fluid), 502 (expression fluid), 503 (assay fluid), the compartmenting structure 506, the assay addition area 507, the selection area 504, the measuring area 505 and the reservoirs 512 and 513 for selected and discarded compartments, respectively. The areas between the compartmenting structure 505 and assay addition area 507 or between the assay addition area 507 and measuring area 505 are the reaction areas I and II, respectively (508 and 510, respectively). In these areas, the expression into the phenotype and the reaction of the phenotype with the assay reagents added, respectively, can take place.

The set-up of the complete microstructured selection module in a side view is represented in FIG. 6. The microstructure 630 is closed by a cover glass 631 (float glass; thickness 170 μm). The valve elements 621, 622, 623, 624, 625 (concealed in FIG. 6) are embodied as miniature valves (Lee Hydraulische Miniaturkomponenten GmbH, Frankfurt am Main, Germany). These microvalves are controlled by an external control unit (constructed by Applicant himself, set-up of the circuit in accordance with manufacturer's instructions, Lee GmbH). The valve elements are fixed within a support structure 633 which is connected with the microstructure 630 by being pressed against it. The hydraulically tight connection of microvalves (621, 622, 623, 624, 625) through connection elements 636 and passages 637 with the reservoirs 601, 602, 603, 612, 613 of the microstructure 630 is achieved by the sealing elements 634. To provide mechanical strength to the complete selection module, the microstructure 630 is supported on a support 632. The support 632 further serves for thermally controlling the selection module. For the optical detection of the biochemical conversion of the reaction in the fluid compartments (as schematically represented in FIG. 1 under number 109), a microscope objective (635) is approached to the microstructure closed with a cover glass in the detection area 605.

The method according to the invention and the microstructure according to the invention are further illustrated by the following non-limiting Example.

### Example

The Example set forth below describes the selection of a sequence-specific endonuclease activity.

Construction and assembly of a microstructure: For the selection of a sequence-specific endonuclease activity, a microstructure according to FIGS. 5 and 6 is selected. The channel structures of such a microstructure are prepared by vacuum ultraviolet ablation from the material PMMA (Poly(methyl methacrylate)). The preparation and use of such microstructures for analyzing biochemical reactions has been repeatedly shown (M. Lapczyna, Dissertation Universität Gesamthochschule Kassel “Vakuum-ultraviolett (VUV)-Laser-induzierte Mikrostrukturierung von Polymer-Substraten für laserspektroskopische Anwendung in der Bioanalytik” (1998); K. Dörre, Dissertation Technische Universität Braunschweig “Machbarkeitsstudien zur DNA-Einzelmolekülsequenzierung in Mikrostrukturen” (2000); K. Dörre et al., Journal of Biotechnology 86, 225-236 (2001); J. Stephan et al., Journal of Biotechnology 86, 255-267 (2001)). The width and depth of the channel is about 1 μm. The reservoirs 601, 602, 603, 612 and 613 are introduced by fine-mechanical machining of the structure.

With the fluorescence-spectroscopic methods described in DE 19757740, biochemical reactions can be determined at a high resolution in microstructured reaction channels as well. Further, the optical system of the microscope enables a visual control of the compartmentation within the microstructure and thus the experimental adjustments of the necessary operational parameters, such as the upstream pressure of the reagent supplies as well as duration and coordination of the switching intervals of the valve elements 621, 622, 623, 624, 625.

Selection for sequence-specific endonuclease activity: Prior to using the expression module, the channel structure is filled with a separation fluid. As the separation fluid, a mixture of perfluorinated aliphatic hydrocarbons (Fluorinert FC40, Art. No. F9755, Sigma Aldrich GmbH, Deisenhofen, Germany) is employed. The separation fluid is inert towards biochemical reactions. Thus, the separation fluid is filled into compartment 501. The filling of the microstructured channels partly happens spontaneously by capillary action. Partial areas of the channels not spontaneously filled can be filled by applying a reduced pressure to compartments 502, 503, 512, 513. Subsequently, all the necessary reagents are introduced into the designated compartments of the microstructure (expression fluid 502, assay fluid 503). Difference volumes to the filling of the whole compartment volume are filled with a water-immiscible coupling fluid (low viscosity mineral oil, Art. No. M5904, Sigma Aldrich GmbH, Deisenhofen, Germany). Also, the reservoirs 512 and 513 are filled with coupling fluid. The coupling fluid serves for the hydraulic coupling between valve elements and the fluid reservoirs through a non-compressible medium. The aqueous expression fluid and the assay fluid are covered with a layer of the coupling fluid. The valve elements 622 to 625 are connected with pressurized reservoirs filled with coupling fluid, and the valve element 621 is connected with a pressurized reservoir filled with separation fluid. The upstream pressure of each reservoir is separately selected for each reservoir.

Opening the valves 621, 622, 623, 624, 625 fills the flexible tube connections and the valves themselves with separation fluid and coupling fluid without the inclusion of gas bubbles. The support module 633 is connected with the microstructure 630 by being pressed against it, again without the inclusion of gas bubbles.

The expression fluid (502) contains an E. coli S30 extract suitable for cell-free protein expression including all further auxiliaries (T7 RNA polymerase etc.) (Lesley, S. A., Methods Mol. Biol. 37, 265 (1995)).

In this experiment, the genotype library based on the gene EcoRI from E. coli is diluted to a concentration of 500 pM plasmide DNA at a temperature of 4° C.

Upon the addition of expression fluid (502 or 602) and separation fluid (501 or 601), the valve elements (621 and 622) of the compartmentation element (506) of the microstructured reaction substrate are controlled to form aqueous genotype compartments having a length of about 2 μm and separation fluid compartments having a length of 10 μm. In channel dimensions of 1 μm×1 μm, the volume of an individual genotype compartment is 2 fl accordingly, and each genotype compartment then bears a statistic average of about 0.6 DNA molecules of the library employed. Correspondingly, about 54% a of the compartments formed do not contain a DNA molecule, 33% of the compartments contain one DNA molecule, and 13% of the compartments contain two or more DNA molecules.

It was found that non-specific nucleolytic activity frequently results in a loss of the DNA employed, so that the concentration of the DNA employed can be selected slightly higher in the nanomolar (1 to 10 nM) range, depending on the application.

The transport speed within the incubation area I (508) of the channel structure is selected to be about 2.0 cm·h⁻¹, so that each genotype compartment formed will have run through about 1 cm of the incubation length I for protein expression after about 0.5 h. After the expression of the phenotype, about 8 fl of the assay fluid (503 or 603) is metered to each of the genotype compartments. The assay fluid (503/603) contains all the components necessary for the endonucleolytic reaction and its detection: 150 mM KOAc, 37.5 mM Tris-acetate, pH 7.6, 15 mM MgOAc, 0.75 mM β-mercaptoethanol, 515 μg/ml BSA, 0.050/a Triton X-100, 0.5% glycerol, 10 nM doubly fluorescence-labeled DNA substrate. According to the methods mentioned in DE 19757740, the endonuclease activity is specifically determined by the addition of doubly fluorescence-labeled DNA substrate.

As the DNA substrate for detecting the endonucleolytic reaction, oligonucleotides labeled with a fluorescent dye are used in accordance with the method described by T. Winkler et al. (Proc. Natl. Acad. Sci. USA 69 (1999), 1375-1376). The substrates employed are represented below:

Oligonucleotide I
Cy5-ATGGCTAATG ACCGAGAATA GGGATCCGAA TTCAATATTG
GTACCTACGG GCTTTGCGCT CGTATC
Oligonucleotide II
RhG-GATACGAGCG CAAAGCCCGT AGGTACCAAT ATTGAATTCG
GATCCCTATT CTCGGTCATT AGCCAT

Cy5 (Amersham Biosciences Europe GmbH, Freiburg, Germany) and RhG (Rhodamine Green from Molecular Probes Inc., Oregon, USA) are typically employed fluorescent dyes. The nucleobases have been abbreviated by the letters A, C, G, T according to a nomenclature known to the skilled person. After heat denaturing, the two oligonucleotides I and II can be annealed to give a double strand which bears the two fluorescent dyes and the specific restriction sequence of the endonuclease EcoRI. The restriction site of the sequence-specific endonuclease EcoRI has been underlined.

Upon the addition of the assay fluid (503 or 603), the average fluid velocity is increased to 3.3 cm·h⁻¹. After an incubation time of 1 h, each genotype compartment passes the incubation area II (510) having a length of 3.3 cm towards the detection element (505 or 605). The endonuclease activity is detected in accordance with the fluorescence-spectroscopic method described by T. Winkler et al. (Proc. Natl. Acad. Sci. USA 69, 1375-1376 (1999)). Such methods can also be applied to microstructures, as could be shown in the above referenced dissertation by K. Dörre. On the selection element (504), the selection of positively evaluated genotype compartments is then effected by controlling the valve elements (624 and 625).

Positively evaluated compartments are thus directed into reservoir 512 by opening the valve element 625, while negatively evaluated compartments are directed into reservoir 513 by opening the valve element 624.

After the selection process is complete, any genotype compartments remaining in the connection channel between the selection structure 504 and the reservoir 512 can be conveyed to reservoir 512 by permanently closing the valve elements 622, 623 and 624 and permanently opening the valve elements 621 and 625.

After releasing the connection between the microstructure 630 and the support structure 633, the mixture of all the positively evaluated genotype compartments is removed from compartment 512. Since the total volume of the genotype compartment present in reservoir 512 is low, an additional volume of 10 μl of buffer (Tris-EDTA buffer, 50 mM tris(hydroxymethyl)aminomethane (Merck KG, Art. No. 1.08382.2500), 10 mM Titriplex III (Merck KG, Art. No. 1.08418.1000, pH 7.0) is manually pipetted onto the bottom of reservoir 512 for removing the genotypes. By repeatedly taking up and dispensing the volume, the genotype compartments can be taken up in the buffer volume. The buffer volume is removed from the compartment, and any transferred residues of separation fluid and coupling fluid can be separated from the aqueous phase by centrifugation and by removal.

By methods known to the skilled person (PCR polymerase chain reaction), the genotypes present in the buffer volume are amplified to be accessible to subsequent molecular-biological manipulations and, if required, to repeated recycling to an expression and selection cycle.

1. A method for the cell-free selection of genotype variants from genotype libraries in a microstructure, comprising the following sequence of reaction steps:
(a) combining a test fluid comprising a genotype library in an expressible form and expression aids suitable for cell-free expression with a separation fluid in the microstructure to form individual compartments of the test fluid;
(b) transporting the compartments through the microstructure, the expression of the genotype into the phenotype being effected in the compartments;
(c) detecting the phenotype in the compartments; and
(d) selecting the compartments in accordance with their phenotypes.

2. The method according to claim 1, wherein an assay fluid with reagents suitable for detecting the phenotype is added to the compartments after step (b).

3. The method according to claim 1 or 2, wherein
said test fluid and expression aids suitable for cell-free expression are selected from aqueous solutions and suspensions of complex compositions, preferably containing a cell extract suitable for in-vitro protein expression; and/or
said separation fluid is a water-immiscible fluid, especially selected from aliphatic and aromatic hydrocarbons, higher alcohols, higher alkanones, esters and ethers of higher hydrocarbons, halogenated hydrocarbons and silicones and mixtures of these substances; and/or
the transport speed of the compartments within the microstructure is from 1×10⁻⁷ to 1×10⁻² m/s, preferably from 1×10⁻⁶ to 1×10⁻⁴ m/s.

4. The method according to one or more of claims 1 to 3, wherein the concentration of said genotype library and said combining of the test fluid and the separation fluid are selected in such a way that a statistic average of only one genotype variant is contained per compartment, and/or wherein the compartment volume is from 0.01 fl to 10 μl, preferably from 0.1 fl to 1 pl, more preferably from 1 to 100 fl.

5. The method according to one or more of claims 2 to 4, wherein said assay fluid is miscible with said test fluid and immiscible with said separation fluid, especially being selected from aqueous solutions, suspensions and emulsions, and the time of the addition is selected in such a way that an amount of gene product sufficient for detection will already have formed by then.

6. The method according to one or more of claims 1 to 5, wherein:
the assay reagents are specific for the function to be selected, especially being those which are suitable for analyzing the function to be selected with optical, preferably fluorimetric, measuring methods; and/or
the detection of the phenotype in the compartments comprises the qualitative and/or quantitative determination of the phenotypical properties and is effected, in particular, by optical, more preferably fluorimetric, methods.

7. The method according to one or more of claims 1 to 6, wherein said phenotype is manifested by endonucleolytic activity.

8. The method according to one or more of claims 1 to 7, wherein said selecting of the compartments is effected by sorting, and/or the method further comprises the reaction step of
(e) isolating the genotype of the selected compartments to form a new genotype library.

9. The method according to claim 8, wherein the genotype library obtained is subjected to one or more further reaction cycles (a) to (d).

10. A microstructure for performing the method according to any of claims 1 to 9, comprising:
a first supply channel for supplying a test fluid (102), especially a fluid containing a genotype, to a reaction channel;
a second supply channel for supplying at least one separation fluid (101) to the reaction channel;
a detection means (205) provided at the end of the reaction channel for detecting a reaction proceeded in the test fluid; and
a selection means for selecting the test fluid compartments (109).

11. The microstructure according to claim 10, characterized by a first metering means (221, 222) connected with the first or second supply channel for the volume-limited supply of test fluid (102) or separation fluid (101), so that compartments (109, 111) are formed in the reaction channel.

12. The microstructure according to claim 11, characterized by a second metering means (222) which is arranged in such a way that one metering means (221, 222) is provided in each of the first and second supply channels.

13. The microstructure according to claim 12, characterized by a control means connected with said metering means (221, 222) by which said metering means (221, 222) can be controlled in such a way that only test fluid (102) and separation fluid (101) are supplied to the reaction channel alternately.

14. The microstructure according to one of claims 10 to 13, characterized by a third supply channel for supplying assay fluid (103) to the reaction channel.

15. The microstructure according to claim 14, characterized in that a third metering means (223) for the volume-limited supply of assay fluid (103) is connected with the third supply channel and further connected with a recognition means for recognizing a test fluid compartment (109) and can be controlled through a signal transmitted from the recognition means so that the assay fluid (103) is supplied to the test fluid compartment (109).

16. The microstructure according to any of claims 10 to 15, characterized in that
said selection means has at least two selection channels (112) connected with the reaction channel, and a selection means (224, 225) for selecting one of the two selection channels (112) depending on the detection result.

17. The microstructure according to claim 16, characterized in that a metering means (224, 225) is provided as a selection means in at least one of said selection channels (112).

18. The microstructure according to any of claims 10 to 17, characterized in that said reaction channels (108, 110) have several individual channels (408, 410) which can be switched in parallel.

19. The microstructure according to claim 19, characterized in that each individual channel has at least one inlet metering means and/or one outlet metering means.

20. The microstructure according to any of claims 10 to 20, characterized in that said metering means (222, 223, 224) are microstructured valve elements.
